(19) United States
(12) Patent Application Publication
(10) Pub. No.: US 2022/0323874 A1
(43) Pub. Date: Oct. 13, 2022

(54) SYSTEMS AND METHODS FOR DYNAMIC PROJECTION MAPPING FOR ANIMATED FIGURES

(71) Applicant: Universal City Studios LLC, Universal City, CA (US)

(72) Inventors: Aaron Chandler Jeromin, Orlando, FL (US); Akiva Meir Krauthamer, Orlando, FL (US); Timothy J. Eck, Windermere, FL (US); Brandon Burnette, Orlando, FL (US)

(21) Appl. No.: 17/714,818

(22) Filed: Apr. 6, 2022

Related U.S. Application Data
(60) Provisional application No. 63/173,327, filed on Apr. 9, 2021.
(60) Provisional application No. 63/177,234, filed on Apr. 20, 2021.
(60) Provisional application No. 63/212,507, filed on Jun. 18, 2021.

(51) Int. Cl. A63G 31/00

(52) U.S. Cl. CPC A63G 31/00

(57) ABSTRACT

A dynamic projection mapping system includes a projector configured to project visible light. The dynamic projection mapping system also includes a calibration assembly having a sensor configured to detect the visible light projected by the projector and an emitter configured to emit infrared light. The dynamic projection mapping system further includes a tracking sensor configured to detect the infrared light emitted by the emitter. The dynamic projection mapping system further includes one or more processors configured to perform a calibration to align the projector and the tracking sensor based on sensor signals received from the sensor and from the tracking sensor.

### CROSS-REFERENCE TO RELATED APPLICATIONS

This application claims priority to and the benefit of U.S. Provisional Application No. 63/173,327 filed Apr. 9, 2021, and titled “Systems and Methods for Dynamic Projection Mapping for Animated Figures,” and U.S. Provisional Application No. 63/177,234 filed Apr. 20, 2021, and titled “Systems and Methods for Dynamic Projection Mapping for Animated Figures,” and U.S. Provisional Application No. 63/212,507, filed Jun. 18, 2021, and titled “Systems and Methods for Dynamic Projection Mapping for Animated Figures,” which are each hereby incorporated by reference in their entirety for all purposes.

### BACKGROUND

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Amusement parks and other entertainment venues contain, among many other attractions, animated figures to entertain park guests that are queued for or within a ride experience. Certain animated figures may be brought to life by projection mapping, which traditionally directs predetermined appearances onto the animated figures. For example, a particular animated figure may be visually supplemented with a canned or fixed set of images, which may align with preprogrammed movements of the animated figure. While such techniques may provide more entertainment than flat display surfaces, it is presently recognized that advancements may be made to further immerse the guests within a particular attraction, ride, or interactive experience. For example, certain animated figures have an internally-positioned projector that generates an unrealistic backlighting or glow via internal or rear projection through a semi-transparent projection surface of the animated figure. As such, it is now recognized that it is desirable to make the animated figures appear more lifelike, as well as to provide the animated figures with the ability to contextually blend with their environment in a realistic, convincing manner.

### SUMMARY

Certain embodiments commensurate in scope with the originally claimed subject matter are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

In one embodiment, a dynamic projection mapping system includes a projector configured to project visible light. The dynamic projection mapping system also includes a calibration assembly having a sensor configured to detect the visible light projected by the projector and an emitter configured to emit infrared light. The dynamic projection mapping system further includes a tracking sensor configured to detect the infrared light emitted by the emitter. The dynamic projection mapping system further includes one or more processors configured to perform a calibration to align the projector and the tracking sensor based on sensor signals received from the sensor and from the tracking sensor.

In one embodiment, a dynamic projection mapping system includes a projector configured to project light. The dynamic projection mapping system also includes a calibration assembly having a sensor configured to detect the light projected by the projector and an emitter configured to emit light. The dynamic projection mapping system further includes a tracking sensor configured to detect the light emitted by the emitter. The dynamic projection mapping system further includes one or more processors configured to establish a common origin within a show space for the projector and the tracking sensor based on sensor signals from the sensor and the tracking sensor.

In one embodiment, a method of operating a projection system and an optical tracking system for dynamic projection mapping includes instructing, via one or more processors, a projector to project visible light. The method also includes receiving, at the one or more processors, a first sensor signal from a sensor of a calibration assembly, wherein the first sensor signal indicates receipt of the visible light at the sensor. The method further includes instructing, via the one or more processors, an emitter of the calibration assembly to emit infrared light. The method further includes receiving, at the one or more processors, a second sensor signal from a tracking sensor, wherein the second sensor signal indicates receipt of the infrared light at the tracking sensor. The method further includes calibrating, via the one or more processors, the projector and the tracking sensor based on the first sensor signal and the second sensor signal.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic diagram illustrating an embodiment of the reactive media system including a projection system and a motion tracking system, in accordance with an embodiment of the present disclosure;

FIG. 2 is a block diagram of an embodiment of the reactive media system of FIG. 1, in accordance with an embodiment of the present disclosure;

FIG. 3 is a front view of human-like facial features projection mapped onto a head portion of an animated figure using the reactive media system of FIG. 1, in accordance with an embodiment of the present disclosure;

FIG. 4 is a front view of animal-like facial features that are projection mapped onto a head portion of an animated figure using the reactive media system of FIG. 1, in accordance with an embodiment of the present disclosure;

FIG. 5 is a perspective view of a show set of an attraction that may utilize the reactive media system of FIG. 1, in accordance with an embodiment of the present disclosure;

FIG. 6 is a perspective view of the show set of the attraction of FIG. 5, wherein an origin point is established for the motion tracking system, in accordance with an embodiment of the present disclosure;

FIG. 7 is a perspective view of the show set of the attraction of FIGS. 5 and 6, wherein the origin point is established for the projection system, in accordance with an embodiment of the present disclosure;

FIG. 8 is a side view of a sensor/emitter assembly that may be utilized to calibrate the projection system and the motion tracking system of FIG. 1, wherein the sensor/emitter assembly utilizes a beam splitter, in accordance with an embodiment of the present disclosure;

FIG. 9A is a side view of a sensor/emitter assembly that may be utilized to calibrate the projection system and the motion tracking system of FIG. 1, wherein the sensor/emitter assembly utilizes fiber-optic strands, in accordance with an embodiment of the present disclosure;

FIG. 9B is an end view of the sensor/emitter assembly of FIG. 9A, in accordance with an embodiment of the present disclosure;

FIG. 10A is a side view of a sensor/emitter assembly that may be utilized to calibrate the projection system and the motion tracking system of FIG. 1, wherein the sensor/emitter assembly includes a housing with multiple light pipes, in accordance with an embodiment of the present disclosure;

FIG. 10B is an end view of the sensor/emitter assembly of FIG. 10A, in accordance with an embodiment of the present disclosure;

FIG. 10C is an end view of the sensor/emitter assembly of FIG. 10A, wherein an emitter includes multiple fiber-optic strands, in accordance with an embodiment of the present disclosure;

FIG. 11A is a side view of a sensor/emitter assembly that may be utilized to calibrate the projection system and the motion tracking system of FIG. 1, wherein the sensor/emitter assembly includes a housing with an emitter, in accordance with an embodiment of the present disclosure;

FIG. 11B is an end view of the sensor/emitter assembly of FIG. 11A, in accordance with an embodiment of the present disclosure;

FIG. 12A is a side view of a sensor/emitter assembly that may be utilized to calibrate the projection system and the motion tracking system of FIG. 1, wherein the sensor/emitter assembly includes a housing with multiple emitters, in accordance with an embodiment of the present disclosure;

FIG. 12B is an end view of the sensor/emitter assembly of FIG. 12A, in accordance with an embodiment of the present disclosure;

FIG. 13A is a side view of a sensor/emitter assembly that may be utilized to calibrate the projection system and the motion tracking system of FIG. 1, wherein the sensor/emitter assembly includes a housing with multiple emitters and a sensor mounted on a printed circuit board, in accordance with an embodiment of the present disclosure;

FIG. 13B is an end view of the sensor/emitter assembly of FIG. 13A, in accordance with an embodiment of the present disclosure;

FIG. 13C is a cross-sectional view of the sensor/emitter assembly of FIG. 13A, taken at line 13C-13C, in accordance with an embodiment of the present disclosure;

FIG. 14A is a side view of a sensor/emitter assembly that may be utilized to calibrate the projection system and the motion tracking system of FIG. 1, wherein the sensor/emitter assembly includes a prismatic light pipe for multiple emitters and a shrouded light pipe for a sensor, in accordance with an embodiment of the present disclosure;

FIG. 14B is an end view of the sensor/emitter assembly of FIG. 14A, in accordance with an embodiment of the present disclosure;

FIG. 15 is a first side view of a sensor/emitter assembly that may be utilized to calibrate the projection system and the motion tracking system of FIG. 1, wherein sensor/emitter assembly includes one or more emitters at the first side, in accordance with an embodiment of the present disclosure;

FIG. 16 is a second side view of the sensor/emitter assembly of FIG. 15, wherein sensor/emitter assembly includes one or more sensors at the second side, in accordance with an embodiment of the present disclosure; and

FIG. 17 is a schematic view of an image that includes indications of multiple markers within an attraction and that may be used to calibrate the projection system and the motion tracking system of FIG. 1, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

Present embodiments are directed to a reactive media system for an amusement attraction, such as an attraction in which a projector of a media control system directs images onto an external surface of a prop, such as an animated figure. By projection mapping onto the external surface of the animated figure, the animated figure may appear more lifelike than certain animated figure systems that internally project images through a semi-transparent surface of an animated figure, thereby generating an unnatural or ethereal glowing appearance. As discussed herein, the reactive media system leverages external tracking (e.g., via optical performance capture or optical motion capture) of the animated figure to dynamically generate and provide images onto the external surface of the animated figure.

In more detail, to enhance the authenticity of the animated figure, the animated figure may be fitted with trackers that enable tracking cameras of a motion tracking system of a media control system to discern movements, positions, and orientations of the animated figure in real-time. The media control system may operate independently of the animated figure (e.g., by not relying on position, velocity, and/or acceleration information regarding actuators of the animated figure), and the media control system may dynamically generate and fit projected images onto the interactive animated figure at a realistic framerate that emulates live characters, such as by presenting textures, colors, and/or movements that appear to be indistinguishable from the animated figure. As will be understood, the media control system may generate and update a skeletal model of the animated figure based on feedback from the tracking cameras. The skeletal model generally represents the moveable portions of the animated figure, and is dynamically updated to represent a current three-dimensional position (e.g., including x, y, and z coordinates), orientation, and scale of the animated figure or portions thereof (e.g., a pose of the animated figure). The media control system therefore utilizes the skeletal model to generate the images for projection that precisely suit the current position and orientation of the animated figure. As discussed herein, a calibration may be carried out to align and to coordinate the tracking cameras of the motion tracking system and the projector of a projection system.

The calibration may be done during the setup of a unified tracking and projection system. The unified tracking and projection system may simplify the calculations needed for calibration as a tracking system and a projection system are rigidly mounted to one another such that displacement of one directly affects the other. For example, accidentally bumping into the projection system frame may displace it a certain distance, but the tracking system would also be displaced the same distance. Advantageously, the adjustments needed to be made may be simplified since adjusting the unified tracking and projection system adjusts the tracking system and the projection system simultaneously. It should be appreciated that the unified tracking and projection system may include various combinations of tracking systems and projection systems. These combinations will be discussed below in further detail, however no one embodiment disparages another and all of the disclosed embodiments may be considered as a plausible solution. While certain examples presented herein refer to an animated figure to facilitate discussion, it should be appreciated that this term is intended to broadly cover any prop that may move within the attraction and/or that may be projected onto via the projection system. Generally, it should be considered that the techniques disclosed herein may be applied to project onto any prop (e.g., object; structure; show action equipment [SAE]). For example, the prop may be a full animated robotic figure. As another example, the prop may be formed by one or more objects (e.g., simpler than a full animated robotic figure) that are moved around via complex SAE. Furthermore, regardless of its structure, the prop may represent a character (e.g., a human-like character, an animal-like character) or may not represent a character (e.g., an inanimate object, such as a building, furniture, water).

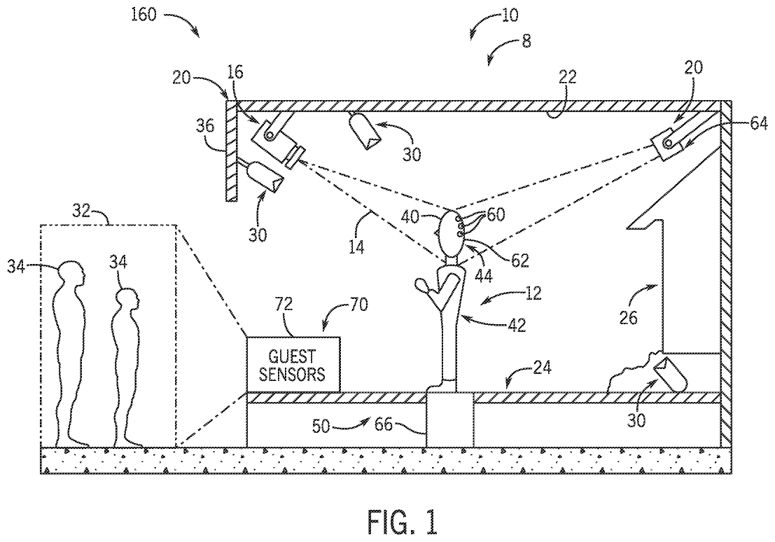

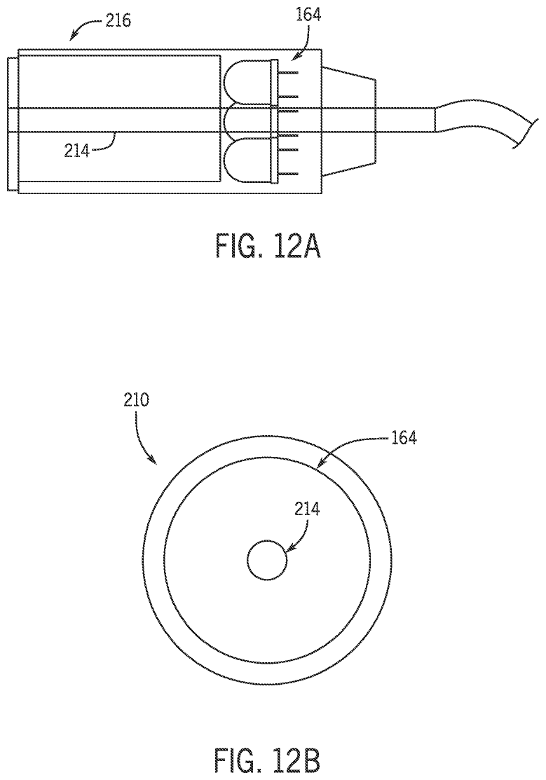

With the foregoing in mind, FIG. 1 illustrates a reactive media system 8 (e.g., dynamic projection mapping system) of an amusement attraction 10 that includes a prop, which may be referred to as an animated FIG. 12, that receives images 14 (e.g., projected content) from a projector 16 (e.g., external projector, optical projector with lens) of a media control system 20. As shown, the amusement attraction 10 is a show set having a stage ceiling 22, a stage floor 24, and scenery objects 26 disposed between the stage ceiling 22 and the stage floor 24. The show set may also include any suitable stage lighting devices 30, such as the illustrated lighting instruments or devices. From a guest area 32 of the amusement attraction 10, multiple guests 34 may view and/or interact with the animated FIG. 12. Although illustrated as within a stage-type environment, it should be understood that the reactive media system 8 may be utilized to entertain guests 34 in any suitable entertainment environment, such as a dark ride, an outdoor arena, an environment adjacent to a ride path of a ride vehicle carrying the guests 34, and so forth.

Notably, the projector 16 is external to the animated FIG. 12, thereby enabling an enclosed volume within the animated FIG. 12 to be utilized to house components other than the projector 16, such as certain actuation systems. In the illustrated embodiment, the projector 16 is disposed in front of the animated FIG. 12 and obstructed from sight of the guests 34 by an overhang 36 of the stage ceiling 22. Regardless of the position of the projector 16, the projector 16 directs the images 14 onto an external surface 40 of a body 42 (e.g., structure) of the animated FIG. 12, which may correspond to a head portion 44 of the animated FIG. 12. The media control system 20 may therefore deliver realistic and engaging textures to the head portion 44, thereby providing an immersive and interactive experience to the guests 34.

As recognized herein, the animated FIG. 12 is part of a motion control system 50 (e.g., prop control system) that may operate independently of the media control system 20. For example, the motion control system 50 may leverage interactive data to dynamically update the animated FIG. 12. It should be understood that the motion control system 50 may instruct actuators to adjust the animated FIG. 12 and/or to adjust the position of any other suitable components of the amusement attraction 10 that may be viewable to the guests 34. For example, the motion control system 50 may control an actuatable motion device 66 (e.g., actuatable motion base) that is physically coupled to the animated FIG. 12. The actuatable motion device 66 may be any suitable motion-generating assembly that may move (e.g., translate, rotate) the animated FIG. 12 laterally, longitudinally, and/or vertically. Furthermore, it should be appreciated that the actuatable motion device 66 may be or include a suspension system and/or flying system that is coupled to the animated FIG. 12 from above the stage floor 24.

Notably, trackers 60 (e.g., trackable markers) may be positioned on the animated FIG. 12. The trackers 60 may be positioned on a back surface 62 or on any suitable surface of the animated FIG. 12. The trackers 60 enable a tracking camera 64 of the media control system 20 to sense or resolve a position and an orientation of the animated FIG. 12 within the amusement attraction 10, such as via optical performance capture or optical motion capture techniques. Thus, as will be understood, the projector 16 may project the images 14 onto the animated FIG. 12 in synchronization with an actual, current position and orientation (e.g., pose) of the animated FIG. 12, without relying on position, velocity, and/or acceleration information from actuators of the animated FIG. 12. However, it should be appreciated that in some embodiments, the media control system 20 may verify the positioning and operation of the projector 16 based on actuator-derived information from the animated FIG. 12.

It should be understood that the reactive media system 8 may include any suitable number of projectors 16, trackers 60, and tracking cameras 64. For example, more than one animated FIG. 12 may be included within a single amusement attraction 10, and the reactive media system 8 may include at least one projector 16 for each animated FIG. 12. However, it is presently recognized that the particular infrastructure of the reactive media system 8 enables any number of animated FIG. 12 that are moveable within an optical range of at least one tracking camera 64 and moveable within a projection cone of at least one projector 16 to receive the images 14. In an embodiment, multiple projectors 16 may be provided to deliver content to multiple sides of a single animated FIG. 12. Additionally, certain embodiments of the animated FIG. 12 may include at least two trackers 60 to enable the tracking camera 64 to resolve the relative positioning of the at least two trackers 60 for efficient tracking of the animated FIG. 12, though it should be understood that changes in position of a single tracker 60 may also enable resolution of the position of the animated FIG. 12 with a less complex system.

In an embodiment, the projectors 16 and the tracking cameras 64 may be physically coupled to one another. For example, the projectors 16 and the tracking cameras 64 may be rigidly mounted to a frame to form a unified system 160 so that the projectors 16 and the tracking cameras 64 remain in fixed positions relative to one another (e.g., with a known offset). As another example, the tracking cameras 64 may be rigidly mounted to frames of the projectors 16. The unified system 160 may simplify a calibration of the projectors 16 and the tracking cameras 64. Further, the unified system 160 blocks (e.g., reduces or eliminates) an amount of drift between the projectors 16 and the tracking cameras 64 during operation of the attraction 10.

Regardless of how the projectors 16 and the tracking cameras 64 are positioned within the attraction 10, the calibration is performed to establish a relationship between the projectors 16 and the tracking cameras 64 to enable the projectors 16 to project the images 14 onto the animated FIG. 12 that are tracked via the tracking cameras 64. The calibration may occur prior to operation of the attraction 10. For example, the calibration may occur before the week begins, each day before the amusement park opens, before each cycle of the attraction 10, or any combination thereof. In an embodiment, the calibration may occur (e.g., be triggered) by a big movement of the animated FIG. 12 (e.g., a threshold distance across the show set).

FIG. 1 illustrates an example of an interactive data source 70 that includes guest sensors 72. The guest sensors 72 may collect guest input from any guests 34 within the guest area 32. As recognized herein, the guest input is one form of interactive data that may be utilized to adaptively update the animated FIG. 12 or the amusement attraction 10. The motion control system 50 may generate a response for the animated FIG. 12 to perform based on the interactive data, and then instruct actuators of the animated FIG. 12 to perform the response.

In an embodiment, the animated FIG. 12 is covered with the trackers 60 (e.g., visible or non-visible; active or passive; retro-reflective markers or active emitters). These discrete points on the animated FIG. 12 may be used directly as visual reference points, on which to base the 2D or 3D pose estimation process. These discrete points may also be identified and fed through a machine learning algorithm, compared against known ground truth surface poses, and pose matches made in real time. In one embodiment, the animated FIG. 12 may be coated with unique patterning, (such as that of facial features imprinted or embedded). The unique patterning may be made up of both infrared reflective and infrared absorbent pigments of a same visible base color, which causes a uniform looking surface in the visible light spectrum (which is best for projecting colored light imagery). However, as viewed through the tracking cameras 64, the patterning would be highly visible and trackable by a trained pose estimation and prediction algorithm running on the hardware. This use of specialized pigments blocks the projected visible light from confusing a visible light sensor tracking system, or having to perform difference calculations from known base surface to frame by frame projected visible light overlays. With this technique, visibly flat surfaces may contain hidden infrared reflecting/absorbing patterning that is viewable by the tracking cameras 64.

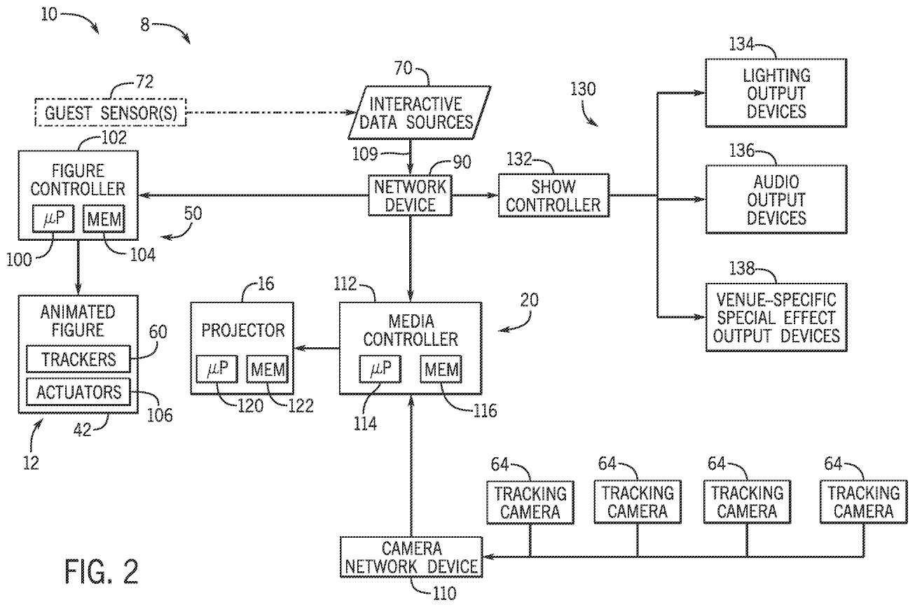

FIG. 2 is a block diagram of the reactive media system 8 having the media control system 20 that may operate to externally project images onto the animated FIG. 12 (e.g., without communicatively coupling to or relying exclusively on the motion control system 50). In an embodiment, the media control system 20 may not directly transmit to or receive communication signals from the motion control system 50. However, as discussed below, the interactive data sources 70 may be communicatively coupled upstream of both the media control system 20 and the motion control system 50 to enable coordination of the media control system 20 and the motion control system 50, without intercommunication between the control systems 20, 50. A network device 90, such as a switch or a hub, may be communicatively coupled directly downstream of the interactive data sources 70 to facilitate efficient communications between the interactive data sources 70 and the control systems 20, 50. However, it should be understood that the network device 90 may be omitted, that multiple network devices 90 may be implemented, or that any other suitable data management device may be utilized to facilitate delivery of data from the interactive data sources 70 to the control systems 20, 50.

In the illustrated embodiment, the animated FIG. 12 includes a figure processor 100 and a figure memory 104, which may collectively form all or a portion of a figure controller 102 of the motion control system 50. The trackers 60 are disposed on the body 42 of the animated FIG. 12 to enable the tracking cameras 64 of the media control system 20 to sense the position and orientation, or pose, of the animated FIG. 12. The trackers 60 may be active devices, which may each emit an individualized signal to the tracking cameras 64. For example, the trackers 60 may emit infrared light, electromagnetic energy, or any other suitable signal that is detectable by the tracking cameras 64 (and, at least in some cases, undetectable by the guests 34). Alternatively, the trackers 60 may be passive devices (e.g., reflectors, pigmented portions) that do not emit a signal and that enable the tracking cameras 64 to precisely distinguish the passive devices from other portions of the animated FIG. 12 and/or the amusement attraction 10.

Moreover, the animated FIG. 12 is fitted with any suitable actuators 106 that enable the animated FIG. 12 to move (e.g., ambulate, translate, rotate, pivot, lip synchronize) in a realistic and life-emulating manner. The interactive data sources 70 may include any suitable data source that provides a variable set of data over time as interactive data 109. For example, the guest sensors 72 may sense guest interactions and relay interactive data indicative of the guest interactions to the figure controller 102. Then, the figure controller 102 may instruct the actuators 106 to dynamically manipulate the animated FIG. 12 to immediately respond to the interactive data 109.

The media control system 20 may include the projector 16, the tracking cameras 64, a camera network device 110, and/or a media controller 112. The media controller 112 is communicatively coupled to the interactive data sources 70 (e.g., via the network device 90), thereby enabling the media controller 112 to dynamically react to the interactive data 109 and/or to other changes in the amusement attraction 10. In an embodiment, the media control system 20 may be communicatively isolated from the motion control system 50. That is, the motion control system 50 may be independent from the media control system 20. Thus, the media control system 20 provides operational freedom to the animated FIG. 12 for adaptively responding to the interactive data 109 in substantially real-time (e.g., within microseconds or milliseconds of an interaction), while the media control system 20 monitors or traces movements of the animated FIG. 12 to project images thereon also in substantially real-time. As such, while the motion control system 50 performs a figure feedback loop, the media control system 20 simultaneously performs a media feedback loop that modifies the images that are projected onto the animated FIG. 12.

To gather information regarding a current position and orientation of the animated FIG. 12, the media control system 20 leverages the tracking cameras 64. A type or configuration of the tracking cameras 64 may be individually selected to correspond to and to detect a type of the trackers 60. The positioning of the trackers 60, in conjunction with geometric or skeletal models of the animated FIG. 12, facilitates coordination of projection onto the animated FIG. 12 in different orientations.

The tracking cameras 64 are communicatively coupled to the camera network device 110, which relays signals indicative of the current three-dimensional position (e.g., including x, y, and z coordinates relative to an origin) and orientation of the animated FIG. 12 or portions thereof (e.g., a pose of the animated FIG. 12) to the media controller 112. The camera network device 110 is therefore a network switch or sensor hub that consolidates multiple streams of information from the tracking cameras 64 for efficient processing by the media controller 112. The media controller 112 includes a media processor 114 and a media memory 116, which operate together to determine, generate, and/or adjust dynamic images to be projected onto the animated FIG. 12 in its current position and orientation. Then, the media controller 112 may instruct the projector 16 to project the dynamic images onto the animated FIG. 12. The images may be wholly rendered on demand based on a current pose (e.g., position and orientation) of the animated FIG. 12. In less complex configurations, the images may be generated by adapting a prerecorded video stream to the current pose of the animated FIG. 12. The media controller 112 may be any suitable media generator or game engine with significant processing power and reduced latency. It should be understood that the media controller 112 is therefore capable of generating the images to be projected onto the animated FIG. 12 in substantially real-time, based on the data received from the tracking cameras 64. Indeed, the media controller 112 may maintain a skeletal model or algorithm that represents the animated FIG. 12 and its actuatable portions (e.g., jaw, limbs, joints). Based on the data, the media controller 112 may update the skeletal model to represent an actual, current position and orientation of the animated FIG. 12, and then generate the images to be projected onto the animated FIG. 12 having the current position and orientation.

The projector 16 may include a projector processor 120 and a projector memory 122 to facilitate the presentation of the images onto the animated FIG. 12. The projector processor 120 generally receives data indicative of the images from the media controller 112, and then instructs a light source within the projector 16 to output the images through a lens. The projector 16 may be moveable or actuatable to follow and align with the animated FIG. 12, such as based on commands received from the media controller 112. Alternatively, the projector 16 may be stationary. In any case, the media controller 112 may determine a current silhouette or a shape of a target figure portion of the animated FIG. 12 that is to receive projected images based on the updated skeletal model, and then instruct the projector 16 to provide the images onto the silhouette.

The processors 100, 114, 120 are each any suitable processor that can execute instructions for carrying out the presently disclosed techniques, such as a general-purpose processor, system-on-chip (SoC) device, an application-specific integrated circuit (ASIC), a processor of a programmable logic controller (PLC), a processor of an industrial PC (IPC), or some other similar processor configuration. These instructions are encoded in programs or code stored in a tangible, non-transitory, computer-readable medium, such as the memories 104, 116, 122 and/or other storage circuitry or device. As such, the figure processor 100 is coupled to the figure memory 104, the media processor 114 is coupled to the media memory 116, and the projector processor 120 is coupled to the projector memory 122. The present embodiment of the reactive media system 8 also includes a show control system 130 that coordinates additional output devices of the amusement attraction 10. For example, a show controller 132 of the show control system 130 is communicatively coupled between the network device 90 and one or multiple lighting output devices 134, audio output devices 136, and/or venue-specific special effect output devices 138 (e.g., fog machines, vibration generators, actuatable portions of the scenery objects 26).

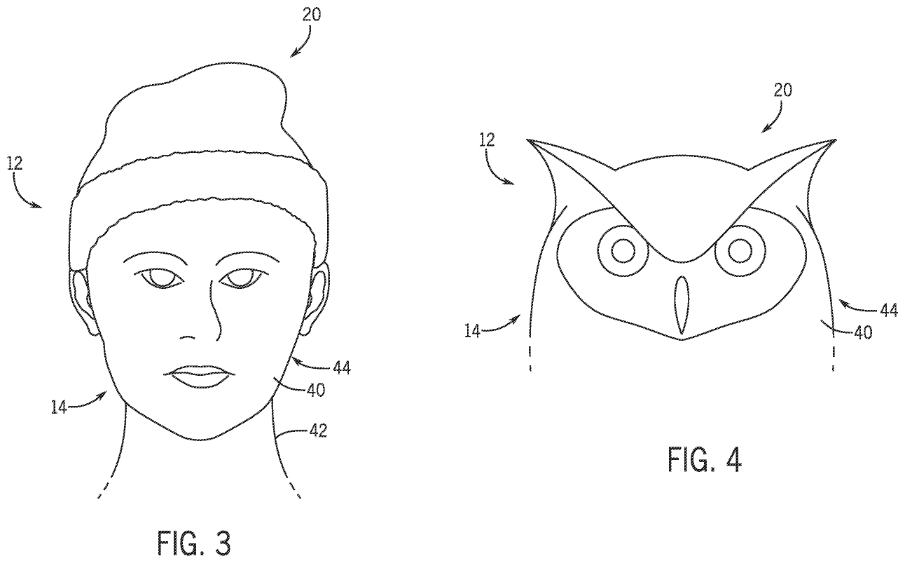

FIG. 3 is a front view of the images 14 provided onto the head portion 44 of the body 42 of the animated FIG. 12. The images 14 may include features or textures that resemble a face. For example, eyebrows, eyes, a nose, lips, and/or wrinkles may be projected on to the head portion 44. The animated FIG. 12 is outfitted with a costume element (e.g., a hat, wig, jewelry), and the media controller 112 and/or the projector 16 may identify an outline of the external surface 40 of the animated FIG. 12 formed by the costume element (e.g., via projection masking). Then, the projector 16 directs the images 14 to a target portion or figure portion of the external surface 40 of the animated FIG. 12. The media control system 20 may monitor movement of the animated FIG. 12, such as large movements across the stage and/or small movements of an articulating jaw, and project appropriate, realistic images onto the head portion 44 of the animated FIG. 12.

FIG. 4 is a front view of the images 14 provided onto the external surface 40 of the animated FIG. 12. As illustrated, the images 14 provide the animated FIG. 12 with a character, non-human, or fanciful appearance, such as the appearance of an owl. The external surface 40 of the head portion 44 may be textured to complement the images 14. It should also be understood that the images 14 may also include supernatural, fanciful, or non-human images and/or effects, such as flames, smoke, shapeshifting, color morphing, and so forth.

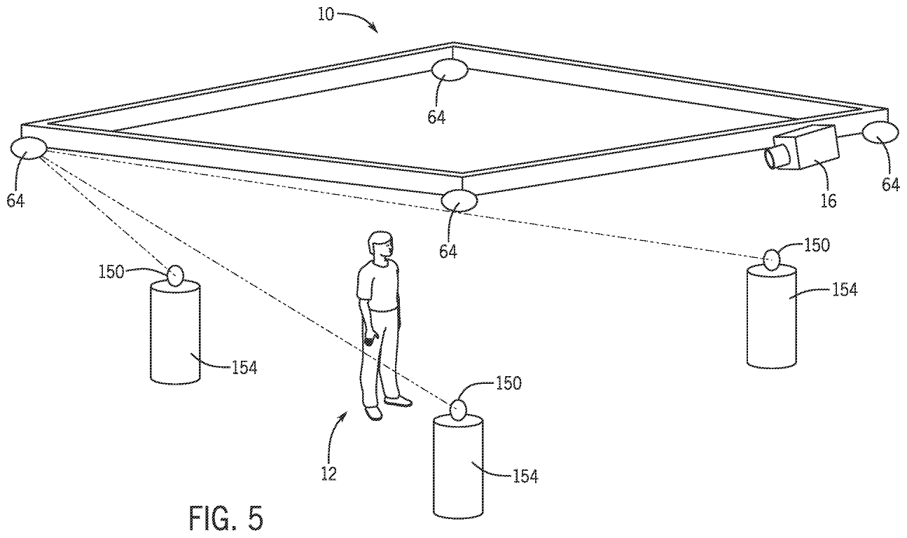

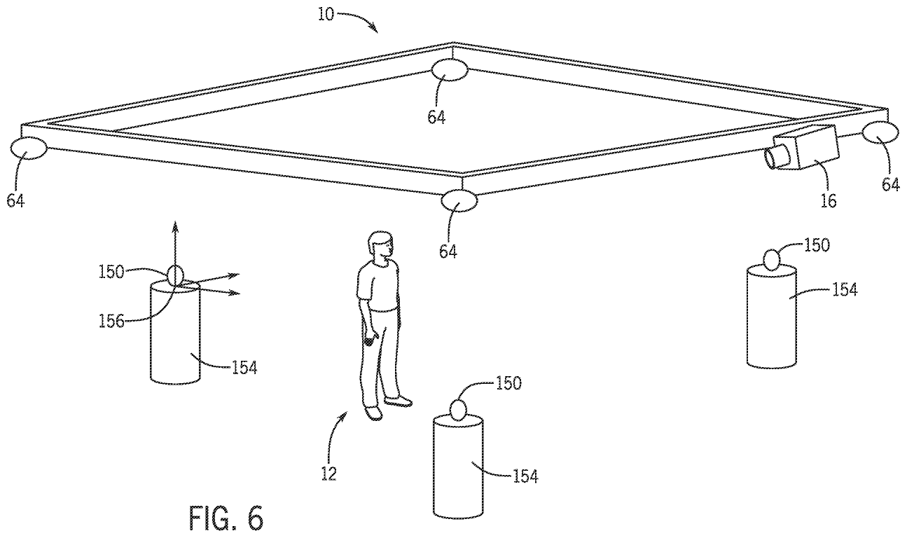

Aspects related to calibration and alignment of the projector 16 and the tracking cameras 64 may be better understood with reference to FIGS. 5-15. In FIG. 5, the amusement attraction 10 is shown including the tracking cameras 64, one or more anchor markers 150, one or more objects 154, and the animated FIG. 12. The tracking cameras 64 may use the anchor markers 150 as reference points to establish a position of the animated FIG. 12 within the amusement attraction 10. For example, FIG. 6 illustrates an embodiment of the attraction 10 including an origin point 156 (e.g., common origin point), which may be centered on one of the anchor markers 150 disposed on one of the objects 154. The object 154 may be static, such that it is stationary during the calibration and during the cycle of the amusement attraction 10 (e.g., and the animated FIG. 12 moves relative to the object 154 during the cycle of the amusement attraction 10).

The origin point 156 on the top of the object 154 may establish a coordinate system (e.g., 2D or 3D; relative coordinate system for the amusement attraction 10) that does not change during the cycle of the amusement attraction 10. Then, the tracking cameras 64 reference the origin point 156 and the coordinate system to track the animated FIG. 12 within the coordinate system. Additionally, as shown in FIG. 7, the projector 16 may also reference the origin point 156 and the coordinate system to enable the projector 16 to accurately project the images 14 onto the animated FIG. 12 during the cycle of the amusement attraction 10 (e.g., at all times and in all poses). In this way, the tracking cameras 64 and the projector 16 are calibrated and aligned with one another. In operation during the cycle of the amusement attraction 10, when the tracking cameras 64 detect that the animated FIG. 12 is at a first set of coordinates, the media controller may then instruct the projector 16 to project the image to the animated FIG. 12 at the first set of coordinates. Because the tracking cameras 64 and the projector 16 have been calibrated and aligned with one another, the image is properly aligned and mapped onto the animated FIG. 12.

It should be appreciated that the media control system may operate generally as a 2D solution (e.g., in an XY coordinate system), such that the animated FIG. 12 is captured with the tracking cameras 64, features or markers of the animated FIG. 12 are identified in 2D space with a shared X/Y origin point of the tracking cameras 64 and the projector 16, and the images are mapped directly to the animated FIG. 12 in the 2D space. In an embodiment, the medial control system may operate generally as a 3D solution (e.g., in an XYZ coordinate system). In such cases, machine learning may be used to solve for an estimation of a pose of the animated FIG. 12 in 3D space. Where the animated FIG. 12 has a face, this may generally be a type of facial tracking in which a machine learning model is trained on an extensive set of labeled and tagged facial images, noting pose, expression, proportions, and surface features. The resulting pose estimation can then be used to project masks or digital costume and effects elements in real time.

Various methods to conduct calibration and alignment of the tracking cameras 64 (e.g., motion tracking system) and the projectors 16 (e.g., projection system) are described in more detail below. The methods may measure the relative position of the tracking cameras 64 of the motion tracking system and the environment, as well as the relative position of the projection lenses of the projectors 16 and the environment. The methods may determine the relative position of the motion tracking system and the projection lens (e.g., establish a common origin and coordinate system).

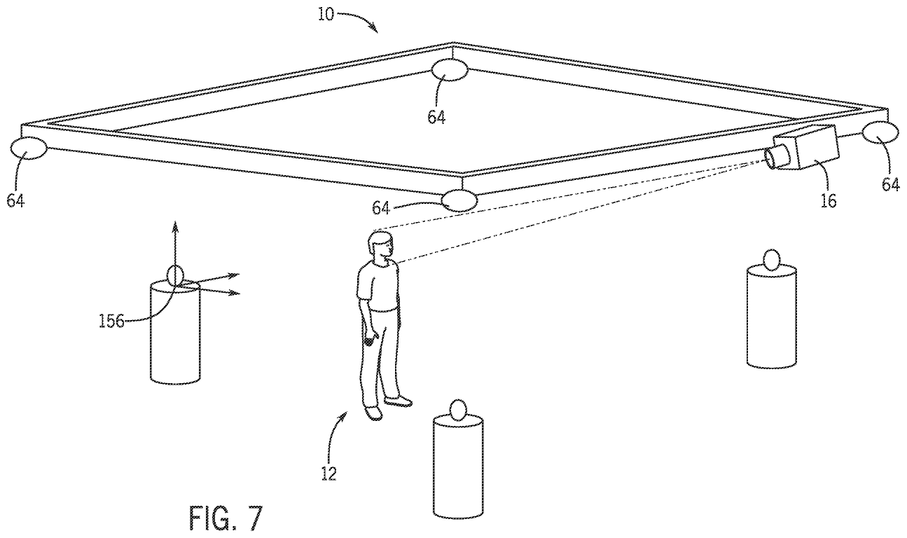

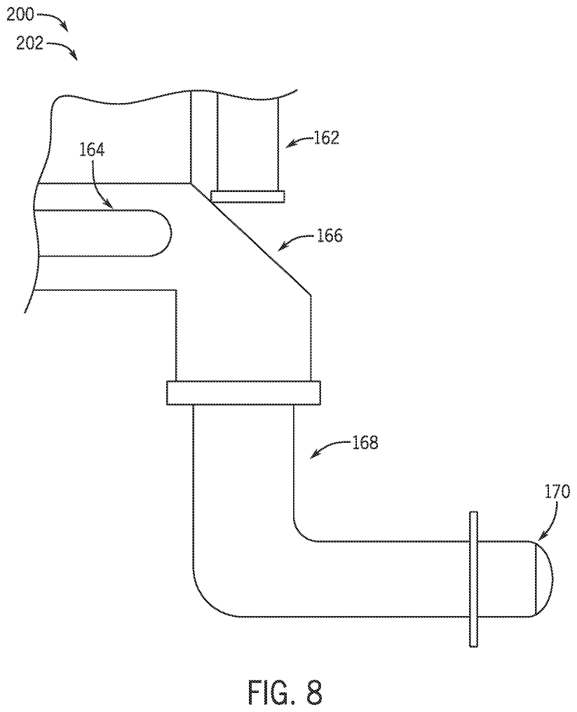

With the foregoing in mind, FIG. 8 illustrates an embodiment of a calibration system 200 with a sensor/emitter assembly 202 (e.g., calibration assembly; co-aligned sensor/emitter assembly). The sensor/emitter assembly 202 may be positioned within the amusement attraction, such as on a stationary object within the amusement attraction (e.g., the object 154 in FIG. 6). In an embodiment, the sensor/emitter assembly 202 may be positioned on a moving object within the show set (e.g., the animated FIG. 12 of FIG. 1); however, the moving object may be stationary during the calibration with the sensor/emitter assembly 202.

As shown, the sensor/emitter assembly 202 may include a sensor 162 (e.g., light detector) and an emitter 164 (e.g., light emitter). The sensor 162 and the emitter 164 may be co-aligned (e.g., coaxial) by means of a beam splitter 166 that is coupled to a fiber optic strand 168. The sensor 162 may be a visible light sensor (e.g., a photodiode) to enable the sensor 162 to detect light from the projectors (e.g., the light from the projectors 16 may only be within the visible light spectrum). Further, the emitter 164 may be an infrared (IR) light emitting diode (LED) to facilitate detection of light from the emitter 164 by the tracking cameras (e.g., the tracking cameras may only capture light with wavelengths associated with IR light). However, the sensor 162 may detect any type of light (e.g., a first type of light), and the emitter 164 may emit any type of light (e.g., a second type of light that is the same or different than the first type of light). The calibration system 200 may further include a sensing area 170 (e.g., end portion; tip) that takes in the visible light from the projectors and that passes the IR light from the emitter 164.

During a sequential process, the emitter 164 may first emit light to enable detection of the light by the tracking cameras and to enable the motion tracking system to determine the coordinates of a point (e.g., at the sensing area 170) in space (e.g., 3D space; the coordinate system). Next, the sensor/emitter assembly 202 is illuminated with a light scan (e.g., structured light or similar) from the projector to enable detection of the light by the sensor 162 at the point in space.

An algorithm in the media controller then makes the two equal to each other (e.g., associated with each other), such that the coordinates (X,Y,Z) of the point in space are equal to a pixel location (X1, Y1) relative to the projector's raster. This process is completed for N co-aligned points in space (e.g., at least 3, 4, 5, 6, 7, or 8) to obtain a matrix of points that can then be used by the media controller to calibrate the motion tracking system and the projection system to accurately project onto a 3D object (e.g., the exterior surface of the animated figure) that moves through the space. It is also possible that certain steps of the process (e.g., the emitter 164 emits the light for detection by the tracking cameras and the sensor 162 detects the light from the projector) could be simultaneously performed to make the process faster. This is due to the beam splitter 166 that can both receive light and emit light at the same time.

In one embodiment, the light scan from the projector 16 may be carried out in a particular manner. For example, a logarithmic or binary search may be used in order to collapse on a single known value in a sorted array. In this case, a pixel position is a known value (based on detection of a max value in data from the sensor 162). To collapse on two known values, (x and y) at the same time, the search algorithm becomes quaternary in nature. From there, the goal becomes determining the location of the sensor/emitter assembly 202 as seen by the projector 16 (e.g., 2D projector) into the show space (e.g., 3D space). This is achieved by establishing four quadrants (e.g., sections; of equal size) and lighting one quadrant up at a time while the other three remain dark. After all four have flashed, the media controller may calculate the sensor 162 that returned a highest value and adjust the zone of interest by setting the limits to the quadrant that caused this. Once this process has been achieved, the zone of interest has been reduced to 25 percent what it was previously. This process will then be repeated (e.g., iterated) until a pixel mapping of a 2D projection to the 3D space is found. This technique may be applied to any calibration process that utilizes the light scan from the projector 16. While quadrants are described to facilitate discussion, it should be appreciated that any number of sections (e.g., 2, 3, 4, 5, or more) may be separately, sequentially illuminated as part of the light scan from the projector 16 to facilitate the calibration. For example, the projector 16 may project the visible light in a first section at a first time, a second section at a second time after the first time, and so on to facilitate the calibration.

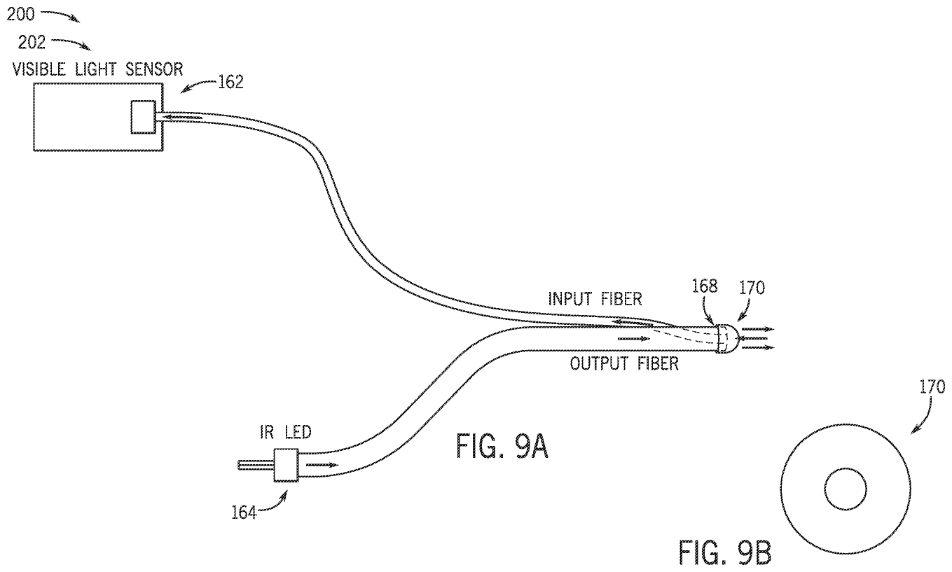

As shown in FIG. 9A, the sensor 162 may be physically separated from the emitter 164. However, to carry out efficient calibration, the fiber optic strands 168 from the sensor 162 and the emitter 164, respectively, may converge into one another at the sensing area 170. While the sensing area 170 shows a lens with a curved end surface (e.g., concave to bend away from the fiber optic strands 168) at an end or tip, it should be appreciated that the lens may be may have a flat end surface. It should be noted that the fiber optic strand 168 running from the sensor 162 may have a smaller diameter than that of the fiber optic strand 168 associated with the emitter 164. The difference in the diameters enables the fiber optic strands 168 to form a concentric ring arrangement at the sensing area 170, as shown in FIG. 9B. In particular, a respective end of the fiber optic strand 168 that extends from the sensor 162 and a respective end of the fiber optic strand 168 that extends from the emitter 164 are concentric (e.g., co-axial; one circumferentially surrounds the other).

Advantageously, the concentric ring arrangement may efficiently calibrate the light from the projector to the 3D space in the attraction. The concentric ring arrangement may include a fiber-optic strand and/or or light-pipe arrangement, a sensor/emitter tip, and/or a sensor amplifier to provide a holistic sensing solution. This may include a customization of a bifurcated fiber-optic diffuse sensor/emitter tip, combined with a sensor amplifier. This may include a custom rigid, flexible, or hybrid light-pipe that is combined with discrete sensors and/or emitters, and this may or may not also utilize a custom printed circuit board.

The emitter 164 and the sensor 162 provide different functionality. For example, the purpose of the emitter 164 is to provide a tracking point or “marker” for the tracking cameras. Any of a variety of IR LED(s) may be utilized as the emitter 164, and the emitter optical output (beam angle) is equivalent to the IR LED specification. In an embodiment, the emitter 164 may emit light at an approximately 850 nm wavelength. The sensor 162 is used to detect visible light from the projectors. A diameter of the sensor 162 (e.g., approximately 1 mm) may be sized to correspond with the size of 1 pixel at a target pixel pitch (e.g., 20 pixels per inch; 0.05 inches or 1.27 mm per pixel); however, the sensor 162 may be larger or smaller than 1 pixel. In another embodiment, the diameter of the sensor 162 may be approximately 0.5 mm. The sensor 162 may have peak response in the human-visible light spectrum. Ideally, the sensor 162 is a high resolution (16 bit) ambient light sensor and provides a linear response in the range of 0-65k lux. In an embodiment, the sensor 162 may have a reading value increase as the light moves closer to a center of the sensor 162, which may enable sub-pixel (e.g., pixel of the projector accuracy. In an embodiment, the sensor 162 may be a small array of sensors (e.g., phototransistor array) to achieve a similar result. In an embodiment, the sensor 162 is immune to IR light (inclusive of light leak from the emitter 164). In an embodiment, the sensor 162 is not a photoresistor or phototransistor.

In an embodiment, a matching sensor amplifier (or equivalent, or similar) shall be connected to the tip of the sensor/emitter assembly 202. In an embodiment, the emitter 164 is always be on (illuminated). Alternatively, the emitter 164 may be controllable, such as via a simple Negative-Positive-Negative (NPN) digital I/O bit. In an embodiment, the sensor 162 is configured to convert the visible light to an analog signal that is either directly outputted as an analog output (e.g., 0-5V, 0-10V, 0-15V, 0-20V, 5-10V, 5-15V, 5-20V), or is sensed as a threshold on the sensor amplifier. Once an adjustable threshold has been detected, a NPN digital output is triggered. The sensor bandwidth or scan rate may be at least 50 Hz, ideally at least 100 Hz (or at least 150 Hz, 200 Hz, 250 Hz). Compatible voltages for the system may be 24 Vdc or 5 Vdc or any other suitable Vdc. The sensor amplifier shall be as small as possible as it will be hidden in unconventional (e.g., non-Deutsches Institut fur Normung [DIN] rail) mounting locations. It should be appreciated that the optical components are isolated (e.g., the IR light emitted by the emitter 164 is isolated from the visible light received at the sensor 162, and vice versa).

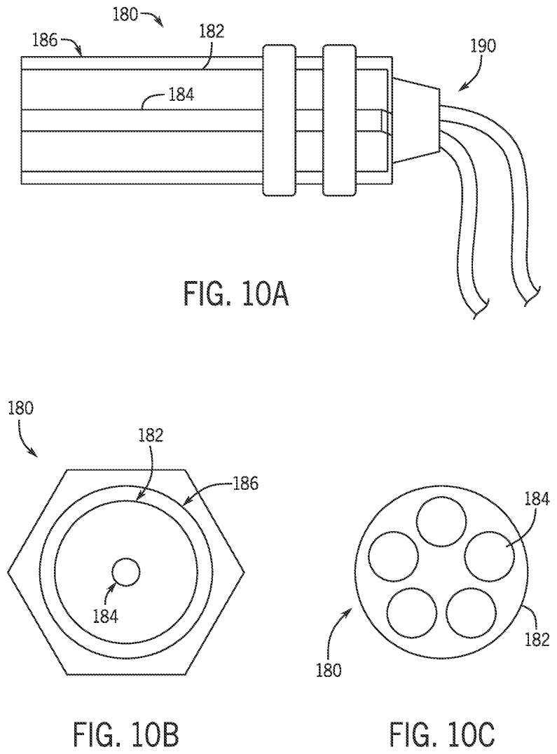

FIGS. 10A-14B illustrate various configurations of a sensor/emitter assembly having a concentric ring arrangement. In particular, FIG. 10A illustrates an embodiment of a sensor/emitter assembly 180 (e.g., calibration assembly) with an output fiber-optic strand 182 and an input fiber-optic strand 184. The fiber-optic strands 182, 184 may be supported within a housing 186 (e.g., annular housing), and the fiber-optic strands 182, 184 may exit the housing 186 at an exit 190 (e.g., termination) to extend to the emitter and the sensor. FIG. 10B illustrates the concentric ring arrangement formed by the emitter (e.g., via the output fiber-optic strand 182) and the sensor (e.g., via the input fiber-optic strand 184). FIG. 10C illustrates an embodiment in which multiple output fiber-optic strands 182 are distributed in a ring.

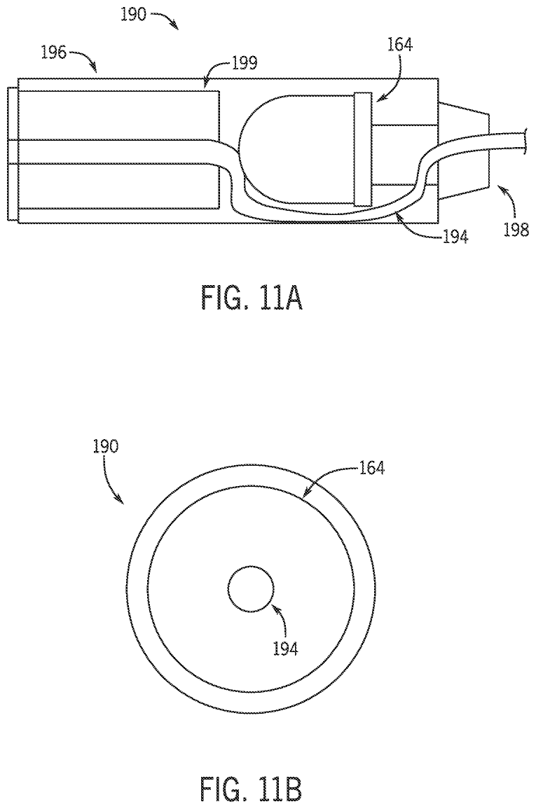

FIG. 11A illustrates an embodiment of a sensor/emitter assembly 190 (e.g., calibration assembly) with the emitter 164, as well as an input fiber-optic strand 194 that extends to the sensor. The emitter 164 and the input fiber-optic strand 194 may be supported within a housing 196 (e.g., annular housing), and the input fiber-optic strand 194 may exit the housing 196 via an exit 198 to extend to the sensor. A light pipe 199 (e.g., annular pipe) may guide the light from the emitter 164. It should be appreciated that the sensor may be supported within the housing 196 instead of the emitter, and then an output fiber-optic strand may be positioned in the housing 196 and exit the housing 196 via the exit 198 to extend to the emitter. FIG. 11B illustrates the concentric ring arrangement formed by the emitter 164 and the sensor (e.g., via the input fiber-optic strand 194).

FIG. 12A illustrates an embodiment of a sensor/emitter assembly 210 (e.g., calibration assembly) with multiple emitters 164 (e.g., arranged in a ring), as well as an input fiber-optic strand 214. The emitters 164 and the input fiber-optic strand 214 may be supported within a housing 216 (e.g., annular housing), and the input fiber-optic strand 214 may exit the housing 216 to extend to the sensor. FIG. 12B illustrates the concentric ring arrangement formed by the emitter 164 and the sensor (e.g., via the input fiber-optic strand 214).

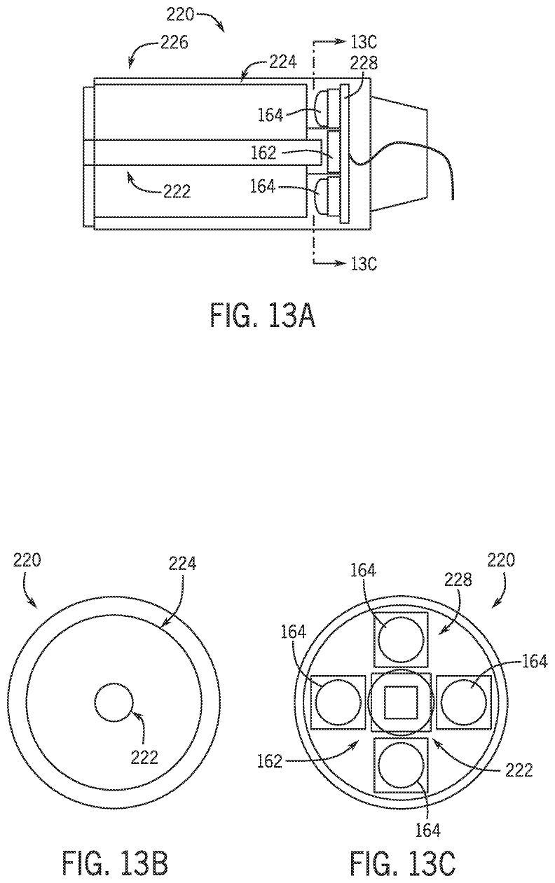

FIG. 13A illustrates an embodiment of a sensor/emitter assembly 220 (e.g., calibration assembly) with multiple emitters 164 (e.g., arranged in a ring), as well as the sensor 162. The emitters 164 and the sensor 162 may be supported within the housing 226. The emitters 164 and the sensor 162 may also be supported on a printed circuit board 228 to facilitate coordinated emission of the light by the emitters 164, as well as processing and communication of light detected via the sensor 162, for example. As shown, a first light pipe 222 (e.g., shrouded light pipe; annular pipe) extends to the sensor 162 to guide and to isolate the light from the projector, and a second light pipe 224 (e.g., annular pipe) surrounds the first light pipe 222 to guide and to isolate the light emitted by the emitter 164. FIG. 13B illustrates the concentric ring arrangement formed by the sensor 162 (e.g., via the first light pipe 222) and the emitters 164 (e.g., via the second light pipe 224). FIG. 13C is taken within line 13C-13C in FIG. 13A, and FIG. 13C illustrates the emitters 164 and the sensor 162 mounted on the printed circuit board 228.

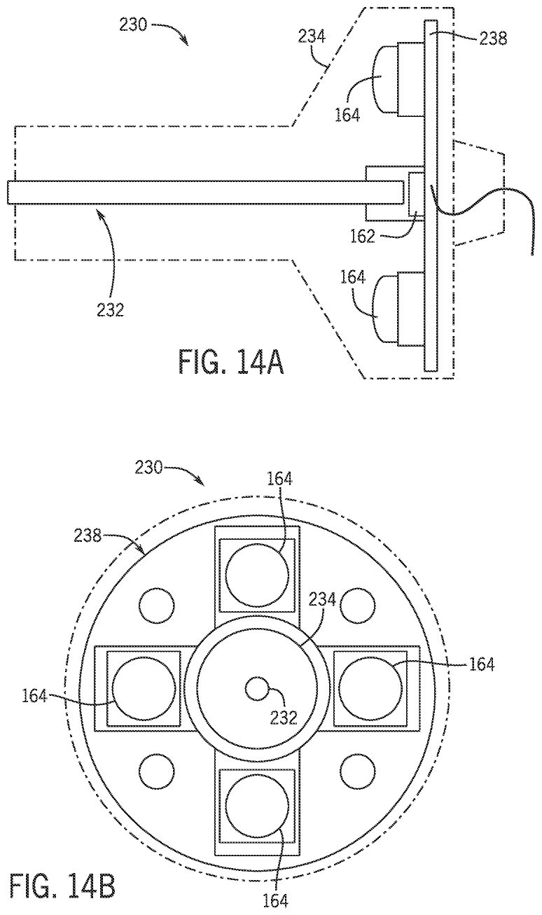

FIG. 14A illustrates an embodiment of a sensor/emitter assembly 230 (e.g., calibration assembly) with multiple emitters 164 (e.g., arranged in a ring), as well as the sensor 162. A first light pipe 232 (e.g., shrouded light pipe; annular pipe) extends to the sensor 162 to guide and to isolate the light from the projector, and a second light pipe 234 (e.g., prismatic light pipe; annular pipe) surrounds the first light pipe 232 to guide and to isolate the light emitted by the emitters 164. The emitters 164 and the sensor 162 may be supported on a printed circuit board 238 to facilitate coordinated emission of the light by the emitters 164, as well as processing and communication of light detected via the sensor 162, for example. FIG. 14B illustrates the concentric ring arrangement formed by the sensor 162 (e.g., via the first light pipe 232) and the emitters 164 (e.g., via the second light pipe 234), as well as the emitters 164 and the sensor 162 mounted on the printed circuit board 238.

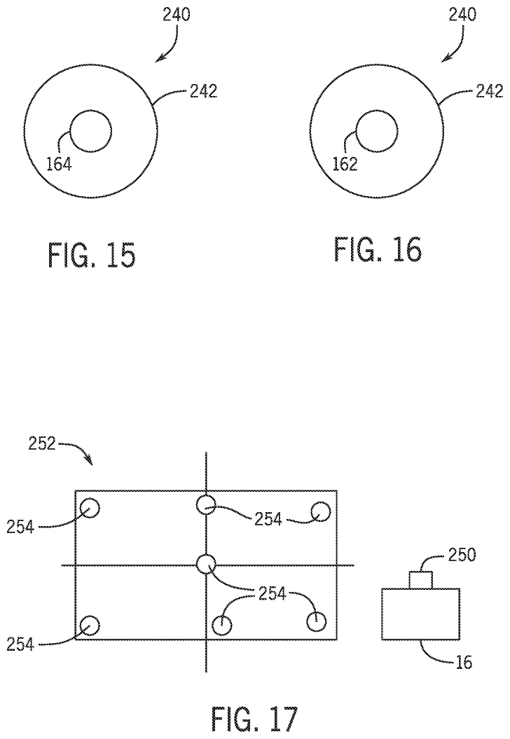

FIG. 15 illustrates a first side (e.g., a front side) of an embodiment of a sensor/emitter assembly 240 (e.g., calibration assembly). In some embodiments, an emitter 164 may be positioned such that the emitter 164 is visible from the first side of the sensor/emitter assembly 240. For example, the emitter 164 may be positioned on a first surface of a housing 242 (e.g., rigid housing; plate). The emitter 164 may function in a similar manner, or the same manner, as described in one or more embodiments mentioned herein.

FIG. 16 illustrates a second side (e.g., a rear side) of an embodiment of the sensor/emitter assembly 240. In some embodiments, a sensor 162 may be positioned such that the sensor 162 is visible from the second side of the sensor/emitter assembly 240. For example, the sensor 162 may be positioned on a second surface of the housing 242 (e.g., opposite the first surface of the housing). The sensor 162 may function in a similar manner, or the same manner, as described in one or more embodiments mentioned herein. With reference to FIGS. 15 and 16, the emitter 164 and the sensor 162 may both be positioned on the housing 242 such that the emitter 164 and the sensor 162 are in fixed positions relative to one another, but may not be co-located (e.g., not facing the same direction and/or one does not circumferentially surround the other). Indeed, in FIGS. 15 and 16, the emitter 164 and the sensor 162 are shown as being positioned on opposite sides of the housing 242 in a co-axial (e.g., aligned) relationship; however, the emitter 162 and the sensor 162 may be positioned on the housing 242 (or on multiple housings or separate structures) such that the emitter 164 and the sensor 162 are in fixed positions relative to one another without being co-located or co-axial. For example, the emitter 164 and the sensor 162 may be located at two different fixed positions in the same plane (e.g., spaced apart from one another in the same plane; co-linear). Indeed, the emitter 164 and the sensor 162 may be located at two different fixed positions in different planes (e.g., offset in three-dimensions) and/or on different housings (or different, physically separate structures). In such cases (e.g., without being co-located), to perform the calibration, the spatial relationship between the sensor 162 and the emitter 164 is known and taken into account. In one embodiment, the housing 242 (or the multiple housings or the physically separate structures) may be coupled to an object that is configured to be worn, held, or carried by the prop (e.g., band, clothing, jewelry, or tool).

The calibration may be carried out via other types of calibration assemblies. For example, with reference to FIG. 17, multiple retro-reflective dots (e.g., markers; 7, 8, 9, 10, or more) may be placed in the attraction (e.g., on walls or objects; on the prop, such as on the animated figure). As part of the calibration, the projector 16 may scan across the raster (e.g., a light scan; across two-dimensional pixels that form the raster). An imaging sensor 250 (e.g., camera) mounted to the projector 16 may capture/generate an image 252 of the attraction. When a pixel of light from the projector 16 hits one of the retro-reflective dots, the imaging sensor 250 detects a bright point 254, and thus, the image 252 includes indications of the bright points 254. Based on the relative locations of all the bright points 254 detected by the imaging sensor 250, the media controller may determine a respective location (e.g., coordinates) that correspond to each of the bright points 254. For example, a first bright point 254 that is in an upper right of the image 252 corresponds to a first retro-reflective dot on a ceiling (e.g., at a first known location/coordinates in the attraction), while a second bright point 254 that is in a lower left of the image 252 corresponds to a second retro-reflective dot on a floor (e.g., at a second known location/coordinates in the attraction). Advantageously, the imaging sensor does not need to be high resolution or well-aligned to the projector.

Based on image 252, the media controller may determine a respective pixel that corresponds to each of the retro-reflective dots (and thus, links the respective pixel to the coordinates in the attraction). The data is provided to a reverse mapping algorithm that calculates a location of the projector 16 relative to the retro-reflective dots (and thus, relative to the coordinates in the attraction/the coordinate system for the attraction).

It should be appreciated that the tracking cameras of the motion tracking system may also detect the retro-reflective dots in the attraction. In an embodiment, at least some of the tracking cameras may include a light source (e.g., light rings) to illuminate the retro-reflective dots to facilitate detection of the retro-reflective dots. Then, the media controller may establish a location of the tracking cameras relative to the coordinates in the attraction/the coordinate system for the attraction. In this way, the projector system and the motion tracking system may share an origin point/coordinate system. Advantageously, this technique provides passive markers (e.g., the retro-reflective dots) and the same markers are used to calibrate/align the projector 16 and the tracking cameras 64. Furthermore, this technique is forgiving of minor movements as the calibration may be completed even if objects (e.g., the walls or the objects in the attraction) move relative to one another.

In an embodiment, the calibration process may utilize detectors (e.g., light detectors; instead of passive retro-reflective dots). For example, multiple detectors may be placed in the attraction (e.g., on the walls or objects; on the prop, such as on the animated figure) at known locations/coordinates. During the calibration process, the projector 16 may perform a light scan across the attraction 10, and each of the detectors may be triggered when the light is detected to provide a X/Y coordinate as position input to the media controller. Then, a reverse mapping is performed to establish a location of the projector 16 relative to the detectors (and thus, relative to the coordinates in the attraction/the coordinate system for the attraction). It should be appreciated that the tracking cameras of the motion tracking system may also detect the detectors in the attraction. In this way, the projector system and the motion tracking system may share an origin point/coordinate system.

In an embodiment, the calibration process may utilize a combination of emitters (e.g., light emitters, such as LEDs; instead of passive retro-reflective dots) and detectors (e.g., light detectors). For example, multiple emitters and detectors may be placed in the attraction (e.g., on the walls or objects; on the prop, such as on the animated figure) at known locations/coordinates. During the calibration process, the projector 16 may perform a light scan across the attraction 10. In response to the detection of the light by the detector, the emitter illuminates (e.g., emits light). The imaging sensor 250 may capture/generate an image that includes indications of the emitters. Then, based on the image, the media controller may determine a respective pixel that corresponds to each of the emitter/detector pairs (and thus, links the respective pixel to the coordinates in the attraction). The data is provided to a reverse mapping algorithm that calculates a location of the projector 16 relative to the emitter/detector pairs (and thus, relative to the coordinates in the attraction/the coordinate system for the attraction). It should be appreciated that the tracking cameras of the motion tracking system may also detect the emitter/detector pairs in the attraction in the same way (e.g., the tracking cameras are associated with a light source).

In an embodiment, the emitters of the emitter/detector pairs may be turned on to emit light (e.g., in sequence or simultaneously). During alignment of the projector 16, detection of light from the light scan of the projector 16 at the detector may cause the emitter to turn off. This may be detected by the imaging sensor 250 to enable the imaging sensor 250 to capture/generate an image that includes indications of the emitters. Furthermore, the light emitted by the emitters may be detected by the tracking cameras. In this way, the projector system and the motion tracking system may share an origin point/coordinate system.

In an embodiment, the calibration process may utilize emitters (e.g., light emitters, such as LEDs; instead of passive retro-reflective dots). The emitters may be placed in the attraction (e.g., on the walls or objects; on the prop, such as on the animated figure) at known locations/coordinates. However, the calibration process may be carried out without any detectors (e.g., light detectors) in the attraction. The emitters may emit infrared light, which may be detected by the imaging sensor 250. During the calibration process, the projector 16 may perform a light scan across the attraction 10. The imaging sensor 250 may detect when the light from the light scan crosses the previously identified emitters. The imaging sensor 250 may be a high-resolution camera and may be configured to capture both visible light and invisible light. In an embodiment, the calibration process may utilize multiple imaging sensors 250, and the data may be averaged and/or compared to provide increased accuracy (e.g., as compared to only one imaging sensor 250). Furthermore, the light emitted by the emitters may be detected by the tracking cameras. In this way, the projector system and the motion tracking system may share an origin point/coordinate system.

In an embodiment, the calibration process may utilize a rigid frame structure that is dropped or otherwise temporarily placed into the attraction (e.g., via an automated and/or motorized system). For example, the rigid frame structure, as well as detectors (e.g., light detectors) coupled thereto, may be passed over with a light scan from the projector 16 to facilitate the calibration process described in detail herein. Once the origin point/coordinate system is established, the rigid frame structure may be removed from the attraction (or the show set of the attraction). Thus, the rigid frame structure is used only temporarily for calibration purposes (e.g., it is brought in, calibration is completed, and then it is taken out).

In such cases, the rigid frame structure may be a space frame (or physical “wireframe”) that actually encompasses an object of interest (e.g., the prop, such as the animated figure) onto which the projector 16 will project images during the show. The rigid frame structure may be the object of interest, such as a piece of show action equipment that is projected onto during the show, but that only makes an appearance during one time period in the show. This calibration technique may work well for an amorphous surface, like a fabric ghost that does not have any geometric features or structure to otherwise mount retro-reflective dots, detectors, or emitters.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A dynamic projection mapping system, comprising:
a projector configured to project visible light;
a calibration assembly comprising a sensor configured to detect the visible light projected by the projector and an emitter configured to emit infrared light;
a tracking sensor configured to detect the infrared light emitted by the emitter; and
one or more processors configured to perform a calibration to align the projector and the tracking sensor based on sensor signals received from the sensor and from the tracking sensor.

2. The dynamic projection mapping system of claim 1, wherein the sensor and the emitter are in a concentric ring arrangement.

3. The dynamic projection mapping system of claim 1, wherein the calibration assembly comprises a housing, and the emitter is positioned to circumferentially surround the sensor within the housing.

4. The dynamic projection mapping system of claim 1, wherein the calibration assembly is coupled to a prop.

5. The dynamic projection mapping system of claim 4, wherein the tracking sensor is configured to track the prop based on detection of one or more trackers coupled to the prop and the projector is configured to project images onto the prop as the prop moves through a show space.

6. The dynamic projection mapping system of claim 1, wherein the one or more processors are configured to establish a common origin point in a show space to align the projector and the tracking sensor.

7. The dynamic projection mapping system of claim 6, wherein the tracking sensor is configured to detect a position of a prop relative to the common origin point, and the one or more processors are configured to instruct the projector to project images onto the prop based on the position of the prop relative to the common origin point.

8. The dynamic projection mapping system of claim 1, wherein the projector is configured to project the visible light in a first section at a first time and a second section at a second time after the first time to facilitate the calibration.

9. A dynamic projection mapping system, comprising:
a projector configured to project light;
a calibration assembly comprising a sensor configured to detect the light projected by the projector and an emitter configured to emit light;
a tracking sensor configured to detect the light emitted by the emitter; and
one or more processors configured to establish a common origin within a show space for the projector and the tracking sensor based on sensor signals from the sensor and the tracking sensor.

10. The dynamic projection mapping system of claim 9, wherein the sensor and the emitter are in a concentric ring arrangement.

11. The dynamic projection mapping system of claim 9, wherein the calibration assembly comprises a housing, and the emitter is positioned to circumferentially surround the sensor within the housing.

12. The dynamic projection mapping system of claim 9, wherein the calibration assembly is coupled to a prop.

13. The dynamic projection mapping system of claim 9, wherein the tracking sensor is configured to track a prop and the projector is configured to project images onto the prop as the prop moves through a show space.

14. The dynamic projection mapping system of claim 13, wherein the tracking sensor is configured to track a position of the prop relative to the common origin point, and the one or more processors are configured to instruct the projector to project the images onto the prop based on the position of the prop relative to the common origin point.

15. The dynamic projection mapping system of claim 9, wherein the emitter is configured to emit infrared light, and the tracking sensor is configured to detect the infrared light emitted by the emitter.

16. A method of operating a projection system and an optical tracking system for dynamic projection mapping, the method comprising:
instructing, via one or more processors, a projector to project visible light;
receiving, at the one or more processors, a first sensor signal from a sensor of a calibration assembly, wherein the first sensor signal indicates receipt of the visible light at the sensor;
instructing, via the one or more processors, an emitter of the calibration assembly to emit infrared light;
receiving, at the one or more processors, a second sensor signal from a tracking sensor, wherein the second sensor signal indicates receipt of the infrared light at the tracking sensor; and
calibrating, via the one or more processors, the projector and the tracking sensor based on the first sensor signal and the second sensor signal.

17. The method of claim 16, wherein the sensor and the emitter are co-axial.

18. The method of claim 16, comprising:
receiving, at the one or more processors, additional sensor signals from the tracking sensor;
processing, via the one or more processors, the additional sensor signals to determine a position of a prop within a show space; and
instructing, via the one or more processors, the projector to project images onto the prop based on the position of the prop within the show space.

19. The method of claim 16, comprising calibrating the projector and the tracking sensor by establishing a common origin point in a show space.

20. The method of claim 16, comprising instructing the projector to project the visible light and the emitter to emit the infrared light simultaneously.
